(19) United States
(12) Patent Application Publication
(10) Pub. No.: US 2005/0052519 A1
(43) Pub. Date: Mar. 10, 2005

(54) Valuable document and security mark using a marking substance

(76) Inventors: Karlheinz Mayer, Augsburg (DE); Dirk Uwe Saenger, Merchweiller (DE); Juergen Zerbes, Muenchen (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/491,530

(22) PCT Filed: Oct. 4, 2002
(86) PCT No.: PCT/EP02/11142

(30) Foreign Application Priority Data
Oct. 5, 2001 (DE) 101 49 265.0

(51) Int. Cl. B41J 2/01

(52) U.S. Cl. 347/105

(57) ABSTRACT

The invention relates to a document of value, a security element and a security marking that have a marking substance absorbing in the infrared spectral region between 1000 and 2500 nanometers which does not significantly absorb either in the visible spectral region or at 800 nanometers. Said marking substance is therefore not accessible with the widespread, simple IR readers working at about 800 nanometers. Preferably, an additional print is added that absorbs in the visible and also at about 800 nanometers but not in the range from 1000 to 2500 nanometers. According to the inventive checking method, the marked place is irradiated with infrared light from the range from 1000 to 2500 nanometers and the absorption determined.

### CROSS-REFERENCE TO RELATED APPLICATION

This application is a §371 of PCT Application Ser. No. PCT/EP02/11142, filed Oct. 4, 2002.

### FIELD OF THE INVENTION

This invention relates to a document of value, a security element and a security marking having a marking substance absorbing in the infrared spectral region which shows no significant absorption in the visible region and is preferably largely transparent, and to a test method and an apparatus for carrying out the test. Such marking substances, incorporated for example into printing ink, can be used to produce markings on any objects or their packaging, which are preferably used for authenticity testing or in the area of logistics, for example for detecting and following flows of goods.

### DESCRIPTION OF THE BACKGROUND ART

EP 0 340 898 B1 discloses a security coding having two identification marks. One identification mark is substantially colorless and absorbs in the near infrared part of the electromagnetic spectrum from 700 to 1500 nanometers. Said first marking is overprinted with a second colored marking opaque in the visible region and not absorbing in the stated infrared spectral region. The marking absorbing in the infrared is detected with a reader working at 780 to 800 nanometers. Such readers working with commercial and inexpensive silicon detectors are meanwhile widespread and accessible to anyone. The visually invisible markings absorbing in the working range of common silicon detectors around 800 nanometers as known from the prior art therefore have the disadvantage that the portion of the marking that should actually remain hidden from the human eye is accessible to unauthorized persons and outsiders without any special difficulties.

### SUMMARY OF THE INVENTION

The problem of the present invention is therefore to propose a way of marking and a method for testing objects and in particular documents of value that meet higher security requirements without having the disadvantages of the prior art.

This problem is solved by the objects and method with the features of the independent claims. Developments and preferred embodiments are stated in the subclaims.

The inventive documents of value, security elements and security markings are characterized by a marking substance having significant absorption in the infrared spectral region from 1000 to 2500 nanometers. In the visible spectral region, however, the marking substance has no or only weak inherent color and therefore shows no significant absorption in this part of the spectrum. The marking substance furthermore shows no significant absorption at a wavelength of or around 800 nanometers.

The marking substance has the advantage that it cannot be detected with the widespread and inexpensive silicon detectors working in the range from about 780 to 800 nanometers.

The IR absorbers used according to the present invention may be not only organic compounds but also inorganic materials, which have better stability to environmental influences. Preferred absorbers are those based on doped semiconductor materials. Especially preferred are metal oxides, which are also characterized by their aging resistance. Preferably, the marking substance is present in an average particle size smaller than 50 nanometers. Thus, visible light is hardly scattered by the particles. The marking substance is colorless or has only very weak inherent color.

The marking substance is preferably applied to the document of value in the form of a print. The marking substance is added here to a binder or a printing ink mixed with coloring pigments. The printing ink or binder must have no significant absorption in the infrared region from 1000 to 2500 nanometers, in particular 1500 to 2000 nanometers. The printed image to be represented by the marking substance is arbitrary and can be for example a logo, alphanumeric characters, a bar code or the like.

However, it is also possible to apply or incorporate the feature substance absorbing in the infrared directly to or into a document of value. Suitable methods for this purpose are for example those described in EP-A-0 659 935 and DE 101 20 818. The pigment particles used for marking a document of value are admixed here to a gas stream or liquid jet and incorporated into a paper web. These methods are suitable in particular for marking so-called security paper as used for producing bank notes for example. It is also possible to add the marking substance to a coating mixture or apply it together with a surface sizing to the surface of a document of value or the substrate materials used for its production. Besides paper and similar fibrous substances, foils into which the feature substance can be incorporated are also suitable for producing documents of value. In foil production the method of coextrusion is in particular suitable for this purpose. This also permits production of foils containing the marking substance only in certain portions or strips.

The marking substance is preferably incorporated or applied not all over but only in selected places or along predetermined tracks. Selective omissions or interruptions in the application or incorporation of marking substance permit codings to be produced. Such codings can be used to render for example batch numbers, lot sizes or product or manufacturer names.

Documents of value according to the invention refer in particular to bank notes but also other documents equivalent to money, such as checks, shares and vouchers. They likewise include ID cards and other identification documents. Such documents of value are frequently provided with an individual serial number. In the inventive documents of value, the serial number is preferably represented in addition to a visually visible representation or exclusively by means of the marking substance absorbing in the infrared. So-called nonimpact printing methods are in particular suitable for this purpose. For rendering signs that are invariable for a large number of documents it is also suitable to use other printing methods, for example offset printing.

The area provided with the marking substance on a document of value can remain free or be combined with a visually visible marking to be explained hereinafter. In particular when the area provided with the infrared absorbing marking substance remains free and the latter has little inherent color in the visible, it may be advantageous to dye the document of value in the color or color tone of the marking substance. A further advantageous way of camouflaging and disguising the marking is to additionally provide the area provided with the marking substance with a lacquer layer or a thin cover foil. Such an additional cover layer must then be sufficiently transparent both at 800 nanometers and in the selected measuring range, which can be between 1000 and 2500 nanometers.

According to a preferred embodiment, the document of value can have a security marking consisting at least of a first print absorbing significantly in the visible and at 800 nanometers and having no significant absorption between 1000 and 2500 nanometers, and a second print having no significant absorption in the visible and at 800 nanometers but significantly absorbing in the spectral region from 1000 to 2500 nanometers.

In a further preferred embodiment of the security marking, the first and second prints are disposed to overlap at least in certain areas.

The inventive security marking has the advantage that it is inaccessible with the widespread and inexpensive silicon detectors working at about 780 to 800 nanometers, since in this spectral region only the print is recognized that is recognizable without technical aids and with the normal human eye due to its absorption in the visible. The marking formed by the second print remains hidden in such measurement since it has no significant absorption at 800 nanometers. The second marking becomes accessible only in the spectral region of 1000 nanometers or more, since appreciable absorption exists only in this range. In particular the infrared region from 1000 to 2500 nanometers is of interest for the stated purposes since it has advantages for detection by measurement technology. The range from 1500 to 2000 nanometers is especially preferred.

For significant absorption in the visible spectral region, which is between about 400 nanometers and about 760 nanometers, it is not necessary that the print absorbs in the total spectral region. Sufficient and effective absorption also exists if there is absorption only in a partial interval of the visible spectral region. The corresponding print is then visible and recognizable to the normal human eye without difficulty in usual lighting conditions and at normal viewing distance. However, the visually visible marking can also be checked by machine with corresponding optical devices, such as scanners or photodiodes, that work at a suitable wavelength. The same applies to the invisible infrared spectral region. Significant absorption in a sufficiently wide interval in which the check can then be effected is sufficient. Absorption is always considered significant when it is perceptible or measurable visually or by machine without special effort or especially elaborate measures of measurement technology. If the absorption of the visually visible print is less than 40%, in particular less than 30%, of its absorption value at 800 nanometers, it is no longer considered significant.

The same applies to the second print, whose absorption is not significant if it less than 40%, in particular less than 30%, of the value it has at the wavelength between 1000 and 2500 nanometers at which infrared testing is performed.

The absorption of a print is usually caused by colorants admixed to a binder, which are present either as soluble dyes or as pigments. However, it is also possible that the binder makes a relevant contribution to the absorption behavior of the print. Binders and colorants are the essential components of a printing ink which can be used for producing the prints forming the security marking.

Both the first and the second print can both form a solid surface and be interrupted. Preferred executions are ones in which the particular print renders additional information. This can for example consist of a logo, national emblem, writing or other alphanumeric characters, or render an image. An especially preferred execution is as a bar code, which permits information to be shown in encrypted form. Execution as a two-dimensional bar code is also possible.

Camouflaging and disguising the second print by the first is especially efficient in particular when the first and second prints are printed substantially on the same surface, i.e. are congruent. Only partly overlapping arrangements are likewise suitable, however. Regardless of the order of their arrangement and their positioning relative to each other, the two prints can have any outline form. They can be symmetric and/or asymmetric. The contours of the two prints can be either the same or different.

All suitable printing methods can be used for producing the prints. The ink jet method is especially preferred, however, since it is a nonimpact-type printing method, which can for example also print nonplanar and curved surfaces without special difficulty. Furthermore, it is especially suitable for producing individual, changing prints, such as a serial number.

The inventive security marking can also be applied to packaging and wrappers such as cardboard packages and foils, or be printed on a tag or label, seal or sleeve and connected subsequently with the actual object to be protected. In another preferred embodiment, the security marking is produced as an intermediate on a transfer band and transferred therefrom to an object to be protected or marked. It is especially preferred to provide the security marking on containers with a refundable deposit, such as bottles or cans, whereby the inventive security marking also has the function of a token.

The inventive security marking is used advantageously wherever the authenticity of an object or document is to be checked. Its use is also advantageous in the area of logistics, since information contained in the marking can be retrieved on different “security levels” during the check of the marking. For example, first information can be visually visible but present in coded form as a bar code, while second information, which can be identical with or different from the first, only becomes accessible upon measurement in the infrared region of 1000 nanometers or more. The second information can also be present additionally in coded form, for example as a bar code.

Preferred applications of the security marking in documents relate to documents of value, such as checks and vouchers, admission tickets, lottery tickets, identification documents, such as passports, company or personal identification cards, documents accompanying goods, such as delivery notes, authenticity certificates and customs documents.

For the first print absorbing significantly in the visible and at about 800 nanometers but not above 1000 nanometers, one can use for example printing inks to which CI Blue 15 and/or Green 7 (CI=Color index) have been added as colorants. It is preferable to use printing inks appearing black visually which arise by subtractive color mixture using red and yellow basic colors and one or both of the aforesaid colorants. The infrared absorber having no effective absorption either in the visible spectral region or at about 800 nanometers that can be used is for example 2,5-cyclohexadiene-1,4-diylidene-bis[N,N-bis(4-dibutylaminophenyl)ammonium]bis(hexafluoroantimonate), having the totals formula C₆₂H₉₂N₆F₁₂Sb₂. It is likewise suitable to use the colorants ADS 990 MC with the totals formula C₃₂H₃₀N₂S₄Ni and ADS 1120 P with the totals formula C₅₂H₄₄Cl₂O₆ which are offered by Siber Hegner GmbH, Hamburg.

The check of the security marking is preferably done automatically, i.e. by machine. Commercial scanners can be used for this purpose, the test beams used preferably being laser light of suitable wavelength. Laser diodes are especially suitable for irradiating the measuring area. The check of the marking substance absorbing in the infrared can be done for example at about 1070 or at 1550 nanometers. If a measurement of absorption is performed in several different spectral regions or wavelengths, the tests can be done both successively and at the same time since they do not influence each other. Absorption of the visually visible fraction can be determined for example at 630 or 650 nanometers.

As mentioned above, it is of special importance for the visually visible print, i.e. the one absorbing in said spectral region, according to the present invention that it also absorbs at or around 800 nanometers. For the visually visible print one can use both color printing inks and black printing inks. Black prints are preferred since they firstly are especially widespread for marking objects, and secondly form especially high contrast on light and transparent objects. Black markings are therefore especially well perceptible. A black print is also especially suitable for covering or hiding the infrared absorbing print.

For the second print absorbing substantially between 1000 and 2500 nanometers to remain inconspicuous and hidden, it is necessary that it has no significant absorption in the visible spectral region. Substances that are transparent and colorless are preferably used here. However, it is also possible to use substances that have only weak inherent color and therefore do not stand out optically or can be easily hidden. In particular in the case of substances with inherent color, their concentration in the second print is to be adjusted so that it has only weak inherent color in the visible spectral region and leads to sufficient absorption in the infrared between 1000 and 2500 nanometers.

A check of the marking substance or the security marking is usually done in reflected light. If the object to which the marking is applied is sufficiently transparent in the relevant spectral region, a check can also be done in transmitted light. The check of the marking substance is preferably done at about 1070 nanometers and/or at 1550 nanometers.

With the inventive combination of prints in a security marking, in which the two prints overlap at least partly but are preferably located completely one above the other, the appearance perceived by the eye or by measurement technology in the visible spectral region is determined almost completely by the first print while the second portion of the security marking is not perceived here. A test of the inventive security marking with inexpensive and widespread infrared detectors working at about 800 nanometers also fails to yield any additional information about the presence or content of the additional second print, since the latter still has no significant absorption at 800 nanometers. Such measurement with simple aids reproduces only the information already accessible in the visible spectral region, since the first print absorbs not only in the visible spectral region but also or still at 800 nanometers. If the test of the security marking is done between 1000 and 2500 nanometers, on the other hand, the measuring result is caused by the hitherto hidden second print, while the first print does not appreciably contribute to the measuring result in this spectral region.

The inventive security marking could not be realized using normal black standard printing ink for the visually visible print, since such ink usually contains carbon black, which still absorbs above 1000 nanometers. The printing inks or dyes mentioned in EP 0 340 898 B1, which presumably absorb in the visible but are not effective above 700 nanometers, also fail to obtain the effect achievable with the present invention, that the visually visible print can still be used to camouflage or disguise the second print in the near infrared at about 800 nanometers.

If, on the other hand, a check is done on an inventive document of value or security element in which the area provided with the marking substance need not necessarily be combined with an additional, visually visible marking, a single measurement of absorption at at least one wavelength, which can be between 1000 and 2500 nanometers, can fundamentally be sufficient. It is thereby checked whether the visually substantially invisible marking exists at the checked place. However, a further measurement is preferably done at another wavelength. The latter is preferably at about 800 nanometers or in the visible spectral region. This permits identification of imitations using for example IR absorbers known from the abovementioned prior art or very broadband absorbing compounds, for example ones containing carbon black. The latter would be recognizable both by measurement of absorption between 1000 and 2500 nanometers and in the visible spectral region, while the authentic, inventive marking substance is only recognizable by measurement done between 1000 and 2500 nanometers.

If it is impossible or undesirable to equip a document of value directly with the marking substance or security marking, these can also be incorporated into an inventive security element. Such security elements can be produced separately and connected with a document of value or any other object to be protected, at any time, for example via an adhesive layer. The security element is preferably executed as a label, seal, sleeve or transfer band, or integrated into one of these. Such prefabricated security elements can be disposed on a for example band-shaped carrier and, when required, transferred therefrom to an object to be protected.

To increase their forgery-proofness, the inventive documents of value and security elements can have further elements that are difficult to imitate, such as watermarks, security threads, diffraction structures or further so-called feature substances. Said feature substances are preferably substances that have luminescence or are magnetic or electroconductive. The check of said additional security features is advantageously done during authenticity testing of the marked objects and documents. According to an advantageous embodiment of the invention, a further print or the visible absorbing first print additionally contains said feature substances. Due to their special physical properties, the feature substances make the print checkable in particular for a further machine test by means of accordingly designed sensors.

### BRIEF DESCRIPTION OF THE DRAWINGS

Further features and advantages of the invention can be found in the drawing and the following description thereof, in which:

FIG. 1 shows a document of value provided with marking substance,

FIG. 2 shows a document of value having marking substance along a track,

FIG. 3 shows a detail of the cross section of a document of value,

FIG. 4 shows a detail of the cross section of a document of value with a coating,

FIG. 5 shows an object with an inventive printed security marking in cross section,

FIG. 6 shows a document with a security marking in a front view,

FIG. 7 shows a label in cross section.

### DETAILED DESCRIPTION OF THE INVENTION

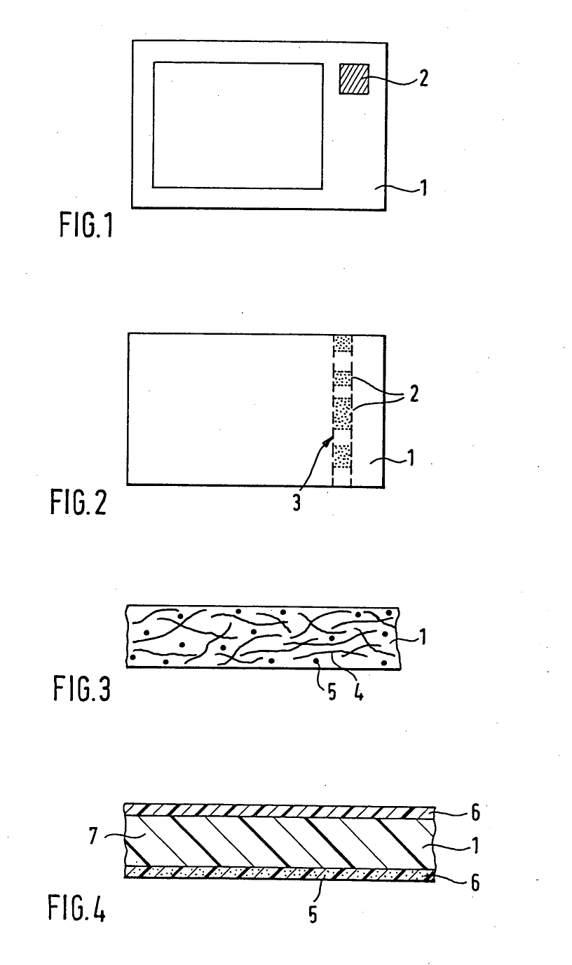

FIG. 1 shows a simple embodiment of inventive document of value 1. This can be for example a bank note. In defined area 2 of document of value 1 the document contains a marking substance absorbing in the infrared but substantially invisible visually. The marking substance can for example be contained in a printing ink and printed on document of value 1. Other coating or transfer methods are likewise possible. Area 2 where the marking substance is present is formed as a simple, unstructured surface in FIG. 1. However, the marking substance can preferably also be applied in a structured form, for example as a pattern, symbol or bar code. Areas 2 provided with the marking substance can also render alphanumeric characters which for example represent the serial number of the document.

In FIG. 2, areas 2 having the marking substance are disposed along predetermined track 3. The track with the marking substances is not continuous but interrupted by areas where no marking substance exists. The position, length and spacing of areas 2 can render for example coded information. Said information can render for example a batch number, the name of the manufacturer or the value of the document, in particular the value of a bank note. Areas 2 can contain the marking substance only on the surface of document of value 1 or also within the volume thereof.

An example of this is shown in FIG. 3. It shows schematically a detail of the cross section of document of value 1. It is formed mainly of fibers 4, which can be paper and/or synthetic fibers. Individual particles 5 of marking substance are embedded into the web-like fiber matrix in irregular distribution. In particular the representation of the size of particles 5 is not true-to-scale. The particles can be added to the paper pulp or fibrous pulp before sheet formation, or incorporated into the fiber matrix after layer formation for example by the methods described in EP-A-0 659 935 and DE 101 20 818. The concentration of particles can vary in document of value 1 and, as shown for example in FIG. 2, be changed selectively along one direction.

A further way of equipping a document of value with a marking substance is shown in FIG. 4. Document of value 1 consists of core layer 7, which is formed for example by a paper or plastic substrate whose upper and lower surfaces were provided with coating 6. Said coating can be for example a coating mixture, surface sizing, opaque paint, lacquer layer or cover foil. One of the two cover layers, the lower one in the shown case, was mixed with dispersed particles 5 of marking substance. It is of course equally possible to apply the marking substance on both sides or incorporate it into one or both of the coatings only in certain areas.

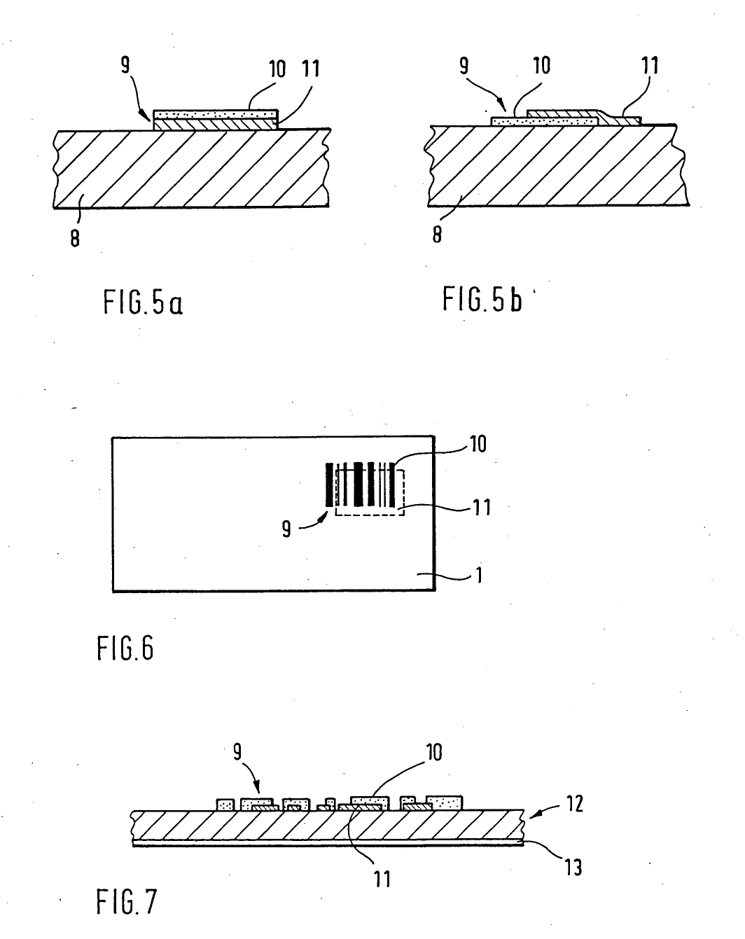

FIG. 5 shows in Figs. a) and b) cross sections of object 8 having security marking 9. In the embodiment according to FIG. 5a), first print 10 absorbing in the visible spectral region is located on the outside and over second print 11 not absorbing in the visible but absorbing in the infrared at 1000 nanometers or more.

In FIG. 5b), prints 10, 11 are disposed in the reverse order. In FIG. 5b) the first and second prints overlap only partly, while in FIG. 5a) they are congruent, i.e. were printed on the same surface. FIGS. 5a) and 5b) show prints 10, 11 as continuous layers. However, it is also possible to execute one or both prints as an interrupted layer or by individual spaced-apart segments. It is therefore not absolutely necessary that two superjacent layers are present in the total overlap area in the areas where the first and second prints overlap. In particular in cases where second print 11 has weak inherent color in the visible, it is advantageous to select an execution according to FIG. 5a) in which outside, visually visible print 10 covers second print 11 and thus hides or camouflages it. The embodiment according to FIG. 5b) in which second print 11 absorbing substantially in the infrared is located on the outside is preferably applied in particular in cases where second print 11 is completely transparent and colorless.

FIG. 6 shows a front view of document 1 bearing security marking 9. Visually visible print 10 was printed by an ink jet method and is executed as a bar code. It largely overlaps with the surface to which second print 11 invisible in the visible was applied. Since second print 11 only absorbs in the infrared above 1000 nanometers but has no inherent color in the visible spectral region and is therefore invisible with the naked eye, only the outline of print 11 is indicated by a dash line in FIG. 6. Visually invisible print 11 can likewise be produced by the ink jet method, but also by another suitable printing method. Print 11 can also be executed as a bar code, but also render other symbols or signs, for example a national emblem or company logo.

In particular for embodiments constructed fundamentally according to the scheme shown in FIGS. 5a, b and 6, it can be advantageous to provide one or more additional ink or lacquer layers which can be located above, below or between the two described. Such additional layers must be substantially transparent in the measuring range between 1000 and 2500 nanometers. With a suitable color tone or gloss, said layers can serve to additionally camouflage the infrared absorbing marking. The additional layers can have the function of a protective layer or a so-called design layer, which integrates the markings graphically into their surroundings.

According to a preferred embodiment, an additional layer or a print can be provided that constitutes a marking or code having significant absorption in the range between 760 and 1000 nanometers. This permits realization of “three-level” marking and protection, which has markings in the visible, in the range of 760 to 1000 nanometers accessible with customary means, and in the highest security range above 1000 nanometers.

FIG. 7 shows label 12 in cross section, which has security marking 9 on one surface and is provided with adhesive layer 13 on the other surface. Suitably adapted adhesive layer 13 can be used to fasten label 12 to any objects. If label 12 comprises a carrier layer transparent in both the visible and the infrared spectral regions, the adhesive layer can also be disposed on the same side as security marking 9. Both print 10 and print 11 are composed of noncontiguous partial segments, as is the case for example with a bar code. Print 10, which is on the outside in this case, occupies a greater surface than print 11. Even if printing ink was not transferred at each place of print 10, prints 10 and 11, i.e. their printing areas, overlap completely. Although not all segments of inside print 11 are covered by printing ink of outside print 10, this is not disturbing since print 11 has at best a weak inherent color in the visually visible spectral region.

1. A document of value (1) having a marking substance absorbing in the infrared spectral region, characterized in that the marking substance has significant absorption in the range from 1000 to 2500 nanometers and has no significant absorption in the visible spectral region and at 800 nanometers.

2. A document of value according to claim 1, characterized in that the marking sub-stance is contained in a printing ink or toner applied to the document of value (1).

3. A document of value according to claim 1, characterized in that the marking sub-stance is incorporated into the substrate of the document of value (1).

4. A document of value according to claim 3, characterized in that the substrate is formed substantially by security paper.

5. A document of value according to claim 1, characterized in that the arrangement or distribution of the marking substance renders information.

6. A document of value according to claim 5, characterized in that the information is coded.

7. A document of value according to claim 6, characterized in that at least part of the information is present as a bar code.

8. A document of value according to claim 1, characterized in that the marking substance represents alphanumeric characters or symbols.

9. A document of value according to claim 5, characterized in that the marking substance represents an individual serial number associated with the document of value (1).

10. A document of value according to claim 1, characterized in that the marking substance has doped semiconductor material.

11. A document of value according to claim 1, characterized in that the marking substance has a metal oxide.

12. A document of value according to claim 1, characterized in that the marking substance is present as particles whose average size is smaller than 50 nanometers.

13. A document of value according to claim 1, characterized in that the document of value (1) is selected from the following group of documents: bank notes, checks, identification documents, documents accompanying goods, customs documents, lottery tickets, admission tickets, vouchers, deposit tokens.

14. A security element for protecting objects which has a marking substance absorbing in the infrared spectral region, characterized in that the marking substance has significant absorption in the range from 1000 to 2500 nanometers and has no significant absorption in the visible spectral region and at 800 nanometers.

15. A security element according to claim 14, characterized in that it is disposed on a carrier in detachable form.

16. A security element according to claim 14, characterized in that it is executed as a label, seal, transfer band or sleeve.

17. A security marking (9) having at least a first and a second print (10, 11), the first print (10) being significantly absorbing in the visible spectral region while the second print (11) has no or only weak inherent color in the visible spectral region, characterized in that the first print (10) absorbs significantly at 800 nanometers and has no significant absorption between 1000 and 2500 nanometers and the second print (11) has no significant absorption at 800 nanometers but absorbs significantly in the spectral region from 1000 to 2500 nanometers.

18. A security marking (9) according to claim 17, characterized in that the first and second prints overlap at least in certain areas.

19. A security marking according to claim 17, characterized in that the first and second prints (10, 11) are substantially congruent.

20. A security marking according to claim 17, characterized in that at least one of the first or the second print (10, 11) comprises a bar code.

21. A security marking according to claim 17, characterized in that the first print (10) is disposed substantially over the second print (11).

22. A security marking according to claim 17, characterized in that at least one of the first or the second print (10, 11) is printed by an ink jet method.

23. A security marking according to claim 17, characterized in that the first print (10) contains the colorant CI Blue 15 or CI Green 7.

24. A security marking according to claim 17, characterized in that the first print (10) is black.

25. A security marking according to claim 17, characterized in that the second print (11) is transparent and has no inherent color in the visible spectral region.

26. A security marking according to claim 17, characterized in that the second print (11) has substances that luminesce, are magnetic or are electroconductive.

27. A security marking according to claim 17, characterized in that it is present in the form of a label (12), seal, sleeve or transfer band which is suitable for transferring the marking (9) to another object or connecting it therewith.

28. A method for checking the authenticity of a security element or a security marking (9) which comprises the steps of:
irradiating the security element or marking (9) with infrared radiation from the wavelength range from 1000 to 2500 nanometers,
determining the absorption of the security element or marking (9) at at least one wavelength from the range of irradiation, and
determining the absorption also at about 800 nanometers.

29. A method according to claim 28, characterized in that the absorption is also measured at at least one wavelength from the visible spectral region.

30. A method according to claim 28, characterized in that the irradiation is effected by means of laser light.

31. A method according to claim 30, characterized in that the irradiation is effected by means of a laser diode.

32. A method according to claim 28, characterized in that a sign, pattern or code represented by the marking substance is determined and evaluated with electronic means.

33. An apparatus for carrying out the method according claim 28 having means for irradiation that emit in the wavelength range from 1000 to 2500 nanometers and means for determining absorption at at least one wavelength from the range of irradiation, and means for determining absorption at about 800 nanometers.

34. An apparatus according to claim 33, characterized in that the means for irradiation has a laser diode.

35. (CANCELED)
